(19) United States
(12) Patent Application Publication
(10) Pub. No.: US 2014/0270323 A1
(43) Pub. Date: Sep. 18, 2014

(54) Speaker Driver

(71) Applicant: Jeffery K. Permanian, Oconomowoc, WI (US)

(72) Inventor: Jeffery K. Permanian, Oconomowoc, WI (US)

(21) Appl. No.: 13/843,893

(22) Filed: Mar. 15, 2013

(51) Int. Cl. H04R 1/00

(52) U.S. Cl. CPC H04R 1/00
USPC 381/394

(57) ABSTRACT

A speaker driver with a high degree of symmetry for use in a loudspeaker is disclosed. The disclosed motor assembly may be symmetrical about its long and radial axes. A voice coil disclosed may be supported by opposing upper and lower suspensions on the voice coil upper and lower ends. The upper and lower voice coil suspensions may be adhered to a frame above and below the motor assembly, respectively.

### CROSS-REFERENCE TO RELATED APPLICATIONS

None

### BACKGROUND OF THE DISCLOSURE

1. Field of the Disclosure

The disclosure relates to speaker drivers and more particularly, to a speaker driver with a symmetrical motor assembly and a symmetrical voice coil support system.

2. Background of the Disclosure

Speaker drivers generally comprise a frame, a motor assembly, a voice coil and a moving assembly. In a pancake style speaker driver, the motor assembly includes a bottom plate supporting a pole piece about which the permanent magnet is concentrically disposed. The top plate, bottom plate and pole piece are typically made of ferromagnetic material. A magnetic gap is formed between the pole piece and the top plate.

The voice coil typically includes a concentrically wound wire around a bobbin known as a former. The voice coil is concentrically hung from its upper end within the magnetic gap of the driver by a moving assembly. When electrical signals from an amplifier pass through the voice coil, it turns into an electromagnet. As the current oscillates, the voice coil moves inwardly and outwardly, pushing the moving assembly. The moving assembly typically includes a surround, a spider and a cone. The surround supports and centers the cone. The surrounds, spider and cone serve to hang the voice coil and center it within the magnetic gap as pushes and pulls air, transforming the electrical signal into sound.

### SUMMARY OF THE DISCLOSURE

The present disclosure provides a speaker driver comprising a motor assembly wherein the motor assembly may be substantially symmetrical about a radial axis and a long axis. Another aspect disclosed is a magnetically symmetrical motor assembly. The present disclosure also provides a speaker driver comprising a voice coil with an upper end and a lower end wherein the voice coil may be supported at its upper and lower ends. In a preferred embodiment, the speaker driver may have a motor assembly and a voice coil support system that may be symmetrical about its long and radial axes.

One aspect of the disclosure provides a speaker driver comprising a frame with motor assembly disposed within the frame. A voice coil may be disposed moveably within a magnetic gap formed within the motor assembly. The voice coil, in one aspect of this disclosure, may be supported from both its lower and upper ends. An upper suspension may be adhered to the outer periphery of the voice coil and the frame above the motor assembly. A lower suspension may be adhered to the outer periphery of the voice coil and the frame below the motor assembly and a cone may be adhered to an inner periphery of the voice coil above the motor assembly. In another aspect of this disclosure, the motor assembly may be substantially symmetrical about a radial axis. In yet another aspect of this disclosure, a voice coil support system may comprise upper and lower suspensions, which are substantially symmetrical about the long axis of the speaker driver. Further still, the speaker driver may comprise a motor assembly and a voice coil support system that may be symmetrical about the radial and long axes of the speaker driver. The speaker driver frame may be made of metal or composite. Preferably, the speaker driver frame may be non-ferromagnetic. More preferably, the speaker driver frame may be aluminum.

The present disclosure, in another aspect, presents a speaker driver having a voice coil with a diameter larger than that of the speaker driver's cone, known in the art as an outside coil. In one embodiment, the winding of the voice coil may be in the inner periphery of the former. This embodiment of the voice coil is known in the art as an inside voice coil. In another embodiment, the winding may be in the inner periphery of the former and on the outer periphery of the former. This embodiment of the voice coil is known in the art as an inside/outside voice coil. In preferred embodiments, the diameter of the voice coil may be from about ninety percent to about one hundred and ten percent of the diameter of the cone. In another preferred embodiment, the diameter of the voice coil is larger than the diameter of the cone. In other aspects, the voice coil may be underhung, wherein the length of the winding is from about ten percent to about ninety-nine percent or evenhung wherein the length of the winding is substantially one hundred percent. The voice coil may preferably be overhung, wherein the length of the winding is greater than the length of the magnetic gap, preferably from about 200 hundred percent to 2000 percent.

The speaker driver disclosed herein may employ a voice coil having a long length in relationship to the length of the former and the length of the speaker driver long axis. In one embodiment, the speaker driver comprises a voice coil winding from about twenty percent to about ninety percent the length of the former. In another embodiment, the voice coil comprises a winding wherein the length of the winding may be from about thirty percent to about eighty percent of the length of the speaker driver along its long axis. Preferably, the winding length may be from about fifty percent to about seventy percent of former length and the former length may be from about forty percent to about sixty percent of the speaker driver length. Naturally, the speaker driver of this disclosure may employ any combination of these length ratios.

Another aspect disclosed may be a voice coil support system having at least two suspensions wherein at least one suspension may be adhered to the speaker driver frame above the motor assembly and at least one suspension may be adhered to the speaker driver frame below the motor assembly. In one preferred aspect, the upper and lower suspensions have arcuate shapes. More preferably, the upper suspension and lower suspensions have opposing arcuate shapes, which, in a further aspect, may be substantially symmetrical about the radial axis. The suspensions may have a variety of shapes, such as half rolls, progressive rolls and corrugated shapes, which may be, in another aspect, arranged in an opposing manner about the radial axis of the speaker driver. Regardless of the number of suspensions used in the disclosed speaker driver, it is preferable to have an even number of suspensions with substantially similar shapes arranged substantially symmetrically about the radial axis 39 of the speaker driver 1 like mirror images.

Another embodiment disclosed is a speaker driver comprising a frame, having an upper end and a lower end; a motor assembly disposed within the frame; and a voice coil, comprising a winding on the outer periphery of a former. The voice coil may be disposed for axial movement within a magnetic gap concentrically formed within the motor assembly. The former, having an upper end, a lower end, an inner periphery and an outer periphery; may be adhered to the upper suspension's inner edge along the outer periphery of the former at the former's upper end. The upper suspension's outer edge may be adhered to the upper end of the frame above the motor assembly. A cone may be adhered to the inner periphery of the former at the upper end of the former. The lower suspension's inner edge may be adhered to the outer periphery of the former at the lower end of the former, while the lower suspension's outer edge may be adhered to the lower end of the frame below the motor assembly.

The present disclosure, in one aspect, provides a voice coil support system for use in a speaker driver comprising an upper suspension and a lower suspension opposingly adhered to opposing ends of the voice coil. Preferably, the opposingly adhered upper and lower suspensions have opposing symmetrical shapes. More preferably, at least two suspensions are adhered to opposing ends of the voice coil wherein the voice coil support system may be substantially symmetrical about its long and radial axes. The voice coil support system may be further configured to adhere to the speaker driver frame in a manner, which may be symmetrical about the long axis of the speaker driver. In another preferable embodiment, the voice coil support system comprises an upper suspension, a lower suspension and a former, the former having an upper end, a lower end and an outer periphery wherein the upper suspension may be adhered to the outer periphery of the former at the upper end of the former and the lower suspension may be adhered to the outer periphery of the former at the lower end of the former wherein the voice coil support system may be substantially symmetrical about its long axis and radial axis.

In a preferred embodiment, a voice coil support assembly for a speaker driver comprises a former having an upper end, a lower end and an outer periphery; an upper suspension having an inner edge and an outer edge wherein the inner edge of the upper suspension may be adhered to the outer periphery of the former at the upper end of the former and the outer edge of the upper suspension may be adapted for adhesion to the upper end of a frame above a motor assembly; a lower suspension having an inner edge and an outer edge wherein the inner edge of the lower suspension may be adhered to the outer periphery of the former towards the a lower end of the former and the outer edge of the lower suspension may be adapted for adhesion to a lower end of a frame below the motor assembly.

This disclosure presents a symmetrical motor assembly. In one aspect, the motor assembly for a speaker driver may comprise annular rings. Preferably, the concentric annular rings may be made from a plurality of radially polarized magnets. Although the motor assembly preferably comprises annular rings made from a plurality of radially polarized arc magnets, one-piece annular permanent magnets may also be used for either the first or second magnet system or both. In one embodiment a motor assembly may comprise a first magnet system fixed in an annular ring forming an inner diameter and an outer diameter; a second magnet system fixed in an annular ring forming an inner diameter and an outer diameter wherein the outer diameter of the second magnet system is smaller than the inner diameter of the first magnet system and a magnetic gap formed between the inner diameter of the first magnet system and the outer diameter of the second magnet system whereby the first magnet system and the second magnet system are operatively coupled by magnetic flux wherein at least one magnetic system comprises a plurality of radially polarized arc magnets. In a preferred embodiment, the motor assembly comprises a first magnet system comprising a plurality of radially polarized arc shaped permanent magnets fixed in an annular ring, may form an inner diameter and an outer diameter. A second magnet system may also comprise a plurality of radially polarized arc shaped permanent magnets fixed in an annular ring forming an inner diameter and an outer diameter. In further aspects, the size of the magnetic systems disclosed may comprise a second magnet system with an outer diameter that is smaller than the inner diameter of the first magnet system. A magnetic gap may be formed between the inner diameter of the first magnet system and the outer diameter of the second magnet system whereby the first and second magnet systems are operatively coupled by a magnetic flux. In aspects, the motor assembly may comprise radially polarized arc magnets forming the annular ring may have from about one to about forty-five degrees of arc. Preferably, the first and second magnetic systems each comprise 36 arc magnets of ten degrees of arc. In a preferred aspect, the motor assembly may be symmetrical about its long and radial axis. In another preferred aspect, the motor assembly may be symmetrically arranged within a speaker driver along its long axis.

This disclosure also provides a frame for a speaker driver comprising at least three j-beams. Each j-beam may have an upper end, a lower end, a shank area, a hook area and a recess, the recess being formed within an inner periphery of the shank area near the lower end of the j-beam. The lower end of the j-beam preferably has a base. The upper end of the j-beam on the hook area may be adapted for attaching an upper ring. Alternatively, the upper ring may be integrally formed with the j-beam. The upper ring may have an inner edge, an outer edge, a top surface and a bottom surface. The upper ring may be adapted to for mounting the at least three j-beams substantially equidistant in a polygonal arrangement with the hook areas of the j-beams arranged inwardly of the outer edge of the upper ring. The frame may also have a lower ring with an inner edge and an outer edge. The outer edge of the lower ring may be held within the recesses of the at least three j-beams shank area. This disclosure also presents an outer ring having an inner edge and an outer edge. The outer edge of the outer ring may be attached to the inner periphery of the shank area of at least three j-beams. Preferably, the outer ring may be attached substantially equidistant from the upper ring and the lower ring. The frame may also use an inner ring adapted for mounting on the upper end of the hook area of at least three j-beams. The inner ring may be preferably concentrically aligned with the outer ring.

The present disclosure also presents a speaker driver comprising a frame having at least three j-beams. In a preferred embodiment, six j-beams may be used. Each j-beam may have an upper end, a lower end, a shank area, a hook area and a recess, the recess being formed within an inner periphery of the shank area near the lower end of the j-beam. The lower end of the j-beam preferably has a base.

An upper edge 36a on the hook area may provide a surface for attaching an upper ring. The upper ring may have an inner edge, an outer edge, a top surface and a bottom surface. The upper ring may be adapted for mounting the at least three j-beams substantially equidistant from each other in a polygonal arrangement. The hook areas of the j-beams may be arranged inwardly of the outer edge of the upper ring.

A lower ring having an inner edge and an outer edge may be held within the recess of the shank area of at least three j-beams by the outer edge of the lower ring, which may add rigidity to the frame and provide a surface for adhering a lower suspension. An outer ring having an inner edge and an outer edge, the outer edge of the outer ring may be attached to the inner periphery of the shank area of the j-beam, providing additional rigidity to the frame. Preferably, the outer ring may be located substantially equidistant between the upper ring and the lower ring. The inner edge of the outer ring may be adapted for mounting the first magnet system. An inner ring having an inner edge and an outer edge may be attached to the upper end of the hook area of the j-beam. The inner ring may be preferably aligned concentrically with the outer ring. The inner ring may be adapted for mounting a second magnet system on its outer edge.

The first magnet system, in other aspects, may be attached to the inner edge of the outer ring. A second magnet system may be attached to the outer edge of the inner ring. A magnetic gap may be formed between the first magnet system and the second magnet system, wherein the first magnet system and second magnet system form a radially aligned motor assembly. A voice coil may be disposed moveably within the magnetic gap providing axial movement. The voice coil may comprise at least one winding wound over a former. The former, having an upper end, a lower end, an inner periphery and an outer periphery may be used to adhere an upper suspension. The upper suspension having an inner edge may be adhered to the outer periphery of the former at the upper end of the former. The outer edge of the suspension may be adhered to the inner edge of the upper ring above the motor assembly. A cone may be adhered to the inner periphery of the former at the upper end of the former. A lower suspension having an inner edge may be adhered to the outer periphery of the former at the lower end of the former. The outer edge of the lower suspension may be adhered to the inner edge of the lower ring below the motor assembly. In a further aspect, the speaker driver may have a first magnet system and second magnet system comprising a plurality of arc magnets.

### NOTATION AND NOMENCLATURE

It should be understood that examples of the more important features of the disclosure have been summarized rather broadly in order that detailed description thereof that follows may be better understood, and in order that the contributions to the art may be appreciated. There are, of course, additional features of the disclosure that will be described hereinafter and which will form the subject of the claims appended hereto.

The following discussion and in the claims, the terms “including” and “comprising” are used in an open-ended fashion, and thus should be interpreted to mean “including, but not limited to . . . ”.

Singular or plural number(s) may also include the plural or singular number respectively.

The word “or” in reference to a list of two or more items, that word covers all of the following interpretations of the word: any of the items in the list, all of the items in the list, and any combination of the items in the list.

### BRIEF DESCRIPTION OF THE DRAWINGS

The advantages and further aspects of the disclosure will be readily appreciated by those of ordinary skill in the art as the same becomes better understood by reference to the following detailed description when considered in conjunction with the accompanying drawings, not drawn to scale, in which like reference characters designate like or similar elements throughout the several figures of the drawing and wherein:

FIG. 1 is a cross-sectional view of one embodiment of a speaker driver of this disclosure.

FIG. 1A is a cross-sectional view of an embodiment of a speaker driver of this disclosure using a multiple roll suspension.

FIG. 1B is a detail of FIG. 1 expanded to illustrate the voice coil placement, including its winding and former, within the magnetic gap formed within the first and magnet systems of the motor assembly.

FIG. 2 is a cross-area view of another embodiment of a speaker driver of this disclosure illustrating use of fasteners on the left side of the long axis and adhesive attachment on the right.

FIG. 3 is a cross-area view of FIG. 2 taken along line 3-3.

FIG. 3A is a detail of FIG. 3 expanded to illustrate the voice coil placement within the magnetic gap.

FIG. 4 is a cross-sectional side and top views of a motor assembly of this disclosure.

FIG. 4A is an expanded view of a portion of an embodiment of a motor assembly illustrating the magnetic flux lines between the magnet systems of a motor assembly of this disclosure.

FIG. 5 is a cross-sectional view of an embodiment of a voice coil support assembly of this disclosure.

FIG. 6A is a cross-sectional top view of an embodiment of an outer ring of a frame embodiment of this disclosure having a hoop and spoke configuration.

FIG. 6B is a cross-sectional top view of an inner ring of a frame embodiment of this disclosure.

FIG. 6C is a cross-sectional top view of an upper ring of a frame embodiment of this disclosure.

FIG. 6D is a cross-sectional top view of a lower ring of a frame embodiment of this disclosure.

FIG. 6E is a cross-sectional side view of a j-beam of a frame embodiment of this disclosure.

FIG. 6F is a top view of an assembled frame embodiment of this disclosure using six j-beams.

FIG. 7 is a cross-sectional view of an embodiment of an assembled frame of this disclosure using three six j-beams.

### DETAILED DESCRIPTION OF THE PREFERRED EMBODIMENTS

The present disclosure in broad aspects, relates to a speaker driver. In other aspects, it relates to a motor assembly, a voice coil support system and a frame, which may be used in the driver. The present disclosure is susceptible to embodiments of different forms. There are shown in the drawings, which will be described herein in detail, specific embodiments of the present disclosure with the understanding that the present disclosure is to be considered an exemplification of the principles of the disclosure and is not intended to limit the disclosure to that illustrated and described herein. The use of “upper,” “lower,” “inner,” “outer,” “top,” “bottom,” “inside,” “outside” and the like refer to the orientation of the speaker driver as it appears in the Figures. Further, while embodiments may be described as having one or more features or a combination of two or more features, such a feature or a combination of features should not be construed as essential unless expressly stated as essential.

Referring now to the drawings, two alternative embodiments of the speaker driver 1 are illustrated in FIG. 1 and FIG. 1A. FIG. 1 is a cross-sectional view of one embodiment of the disclosed speaker driver 1. The speaker driver 1 includes a frame 2; a motor assembly 4; a voice coil 10, an upper suspension 14, a lower suspension 16 and a cone 18. The concentrically disposed voice coil 10 is typically made by winding wire around a bobbin, known as the winding 11 and former 12, respectively. The winding comprising at least one wire wound about the former 12 leaves the upper end and lower ends (10a, 10b) ends of the voice coil 10 bare for adhesion to the suspensions 14, 16 and the cone (18). In aspects, the voice coil 10 of embodiments of this disclosure may be inside coils (not shown), outside coils or inside outside voice coils (not shown). The motor assembly 4 comprises two annular magnet systems 24, 26 concentrically disposed within the frame 2. The voice coil 10 is shown substantially bisecting a magnetic gap 5 formed between the two magnet systems 24, 26.

Continuing, FIG. 1 illustrates another embodiment having an upper suspension 14 and lower suspension 16 adhered to the upper and lower ends of the frame 2a, 2b on opposite sides of the motor assembly 4. Suspensions typically used in the art are commonly called surrounds and spiders. Surrounds are generally made from a foam or butyl rubber. Surrounds may have be cupped, flat, corrugated or have progressive rolls. A preferred arcuate shape for a surround may be a half-roll, but more preferably progressive rolls. Spiders are typically corrugated and made from a stiffer material, preferably fabrics such as cotton, polypropylene or Nomex®. FIG. 1A illustrates an embodiment having corrugated suspensions. A preferred embodiment may use spiders of Nomex® having progressive rolls. Both suspension types have inner and outer circumferential edges for adhesion to the voice coil 10 and frame 2, respectively. As illustrated in FIG. 1 and FIG. 1A, the upper (14, 14′) and lower suspensions (16, 16′) of these embodiments may be respectively adhered between the voice coil 10 at the upper and lower ends 10a, 10b of the voice coil 10 and frame 2 on opposite sides of the motor assembly 4 allowing the voice coil 10 to move up and down the long axis 40. FIG. 1 and FIG. 1A also illustrate use of opposing suspensions 14, 16. The suspensions 14, 16 may have arcuate shapes, which mirror each other symmetrically about the long and radial axes (40, 39) of the speaker driver 1. In another embodiment, the upper suspension 14 may be adhered to the outer periphery 10d of the voice coil 10 and the frame 2 above the motor assembly 4. In a further aspect of this embodiment, the lower suspension 16 may be adhered to the outer periphery 10d of the voice coil 10 and the frame 2 below the assembly 4.

The motor assembly 4 illustrated in FIG. 1 comprises two permanent annular ring magnets disposed concentrically within the frame 2. The permanent annular ring magnets systems 24, 26 may be high-grade ferrite, strontium or AlNiCo alloys; however, neodymium is preferred. The first magnet system 24 may be disposed outside the second magnet system 26. An embodiment of the motor assembly 4 illustrated in FIG. 1 is symmetrical about the long axis 40 and radial axis 39 of the speaker driver 1. Unlike prior art speaker drivers, having magnetic return paths through magnetically conducting top plates, pole pieces and sidewalls, preferred embodiments of this disclosure may use materials which do not conduct magnetically. The result may be a substantially symmetrical magnetic flux within the magnetic gap as depicted in FIG. 4B. FIG. 1 also illustrates an embodiment of an overhung voice coil 10 wherein the amount of winding 11 above and below the motor assembly 4 about the long axis 40 of the driver 1 may be substantially equal. When electrically excited, the amount of winding within the magnetic flux may be substantially constant resulting in an electrically symmetrical motor structure 4.

The cone 18 of the driver 1 may be circumferentially adhered to the inner periphery 10c of the voice coil 10 at the upper end 10a of the voice coil 10. Typical cone materials are paper, PMI (closed cell polymethacrylimide available from Evonik, HCL (HoneyCombLaminate), pearl mica, thermalum, aluminum and titanium coated polypropylene, PBO fiber, and various fabrics such as Nomex®, Kevlar® and Mylar® available from DuPont. When electrical signals from an amplifier (not shown) pass through the voice coil 10, it turns into an electromagnet. As the current in the voice coil 10 oscillates, its polarity reverses and the voice coil 10 is alternately attracted to and repealed by fixed poles of the first and second magnet systems 24, 26. The voice coil 10 thus moves up and down the long axis 40 of the speaker driver 1, pushing and pulling the cone 18, which pushes and pulls air, transforming the electrical signal into sound.

Referring now to FIG. 2, a speaker driver 1 having a frame 2 comprising six j-beams 6 is illustrated. The j-beams, as depicted in FIG. 6E, may have a an upper end 6a, a lower end 6b, a shank area 7, a recess 7n within the j-beam inner periphery 7d, and a hook area 36. The lower end 6b of the j-beam 6 has a base 34 illustrated by the flattened area. Referring again to FIG. 2, the frame 2 may be assembled using at least four rings, an upper ring 3, a lower ring 22, an outer ring 20 and an inner ring 21. The j-beams 6 are preferably arranged equidistant from each other. The four rings may be attached to the j-beams 6 using means known in the art, e.g., fasteners, adhesive, welding and the like. FIG. 2 illustrates use of fasteners for rings 3, 20 and 21 left of the long axis 40 and adhesive on the right side of the long axis 40. Use of welding is not shown. FIG. 6c illustrates an upper ring 3 adapted for mounting six j-beams in a hexagonal arrangement. The perimeter of the outer edge 3b of the upper ring 3 may be shaped as desired for mounting the speaker driver 1 into a speaker cabinet (not shown) using fasteners through optional openings 3f.

The lower ring 22 may be used to secure the lower ends of the j-beams 6b as seen in FIG. 2. The hook areas 36 of the j-beam 6 may be preferably arranged interiorly from the outer edge (3b) and the inner edge (3a) of the upper ring 3 of the j-beam 6 before inserting the outer edge 22b of the lower ring 22 into the shank recess 7n. The lower ring 22 may be preferably attached by adhesive within the shank recess 7n for extra stability. The inner edge 22a edge of the lower ring 22 may be adapted for attaching the outer circumferential edge of the lower surround 16b, preferably using adhesive. The inner edge 22a of the lower ring 22 may protrude interiorly from the shank section 7 or the length of the inner ring 22 may be less than the length of the shank recess 7n to facilitate adhering the outer circumferential edge 16b of the lower suspension 16 to the inner edge 22a of the inner ring 22.

As illustrated in FIG. 2, the outer ring 20 may be used to attach the first magnet system 24. The first magnet system 24 may be preferably attached to the inner edge 20a of the outer ring 20. FIG. 6A is a cross-area view of the outer ring 20. The outer ring 20 may be annular shaped, but preferably has a hoop and spoke design. The outer edge 20b of the spoke area 20c, or the outer edge 20b of the hoop area 20e if an annular ring rather than a spoke and hoop embodiment is used, of the outer ring 20 may be attached to the inner periphery 7d of the shank area 7 by adhesive as illustrated on the right side of the long axis 40 in FIG. 2 or using fasteners as illustrated on the left side of the long axis 40 in FIG. 2. The outer ring 20 may be attached to the inner periphery 7d of the shank area 7 substantially midway between the upper ring 3 and the lower ring 22.

The inner ring 21 may be used to attach the second magnet system 26. The second magnet system 26 may be preferably attached to the outer edge 21b of the inner ring 21. The inner ring 21 may be mounted on the upper edge 36a of the hook area 36 of the j-beam 6. The inner ring 21 may be attached using adhesive or may be attached using fasteners as illustrated on the right and left side of the long axis 40 in FIG. 2.

Continuing with FIG. 2, the cone 18 may be adhered to the voice coil 10 at the upper end 12a of the former 12 on the inner periphery 12c of the former 12. An embodiment illustrated in FIG. 2 has a suspension system of surrounds and/or spiders supporting the upper end 10a and lower end 10b of the voice coil 10 by adhesion to the outer periphery 12d of the former 12 of the voice coil 10 at the upper end 12a of the former 12 and by adhesion to the outer periphery 12d of the former 12 of the voice coil 10 at the lower end 12b of the former 12. The upper suspension 14 depicted in FIG. 2 is a half roll. In this embodiment, the outer edge 14b of the upper suspension 14 may be adhered to the inner edge 3a of the upper ring 3 above the motor assembly 4. The inner edge 14a of the upper suspension 14 may be adhered to the upper end 12a of the former 12 of the voice coil 10 along the outer periphery 12d of the former 12 of the voice coil 10. The outer edge 16b of the lower suspension 16 may be adhered to the inner edge 22a of the lower ring 22 below the motor assembly 4. The inner edge 16a of the lower suspension 16 may be adhered to the lower end 10b of the voice coil 10 along the outer periphery 12d of the former 12 of the voice coil 10 at the lower end 12b of the former 12 of the voice coil 10. Thus, in aspects, the voice coil 10 of this embodiment may be supported by adhesion of at least two suspensions, at least one on its upper end 10a and at least one on its lower end 10b. In some embodiments upper and lower suspensions of may be of dissimilar shape (not shown). FIG. 2 illustrates an upper suspension 14 having a half roll substantially similar to the lower suspension 16. Preferably, the upper and lower suspensions 14, 16 are adhered to oppose each. More preferably, the upper suspension 14 and the lower suspension 16 are symmetrically opposed about their long and radial axes, like a mirror as illustrated in FIG. 2.

The lengths of the magnet gap L₁, the winding L₂, the former L₃ and the speaker driver L₄ are illustrated in FIG. 2. The voice coil 10 of this illustrated embodiment is overhung, having a winding length L₂ longer than the magnetic gap length L₁. Although the speaker driver 1 of this disclosure may use an underhung voice coil 10, wherein the winding length L₂ is shorter than the magnetic gap length L₁ or an evenhung voice coil wherein the winding length L₁ is substantially equal to 100 percent of the magnet gap length L₁ using an overhung voice coil 10 may be preferred. The winding length L₂ may be at least twenty percent the length of the former L₃ and may be from about thirty percent to about eighty percent of the length of the speaker driver L₄. The winding length L₂ may be preferably configured to have the same amount of winding within the magnetic gap 5 corresponding to the maximum designed excursion of the cone 18.

FIG. 3 is a cross-sectional top view of the speaker driver 1 embodiment in FIG. 2 taken along the section line 3-3. FIG. 3 illustrates the radial symmetry of the speaker driver 1. Reviewing the elements from the outermost to the innermost, one may see the j-beam 6; the outer edge 20b of the outer ring 20, the outer ring 20 (including the spoke area 20c and the hoop area 20e), the inner edge 20a of the outer ring 20; the outer edge 24b of the first magnet system 24, the first magnet system 24, the inner edge 24a of the first magnet system 24; a outer portion of the bisected magnetic gap 5b; the voice coil 10 (including the winding 11 and the former 12); the inner portion of the bisected magnetic gap 5a; the outer edge 26b of the second magnet system 26, the second magnet system 26, the inner edge 26a of the second magnet system 26, the outer edge 21b of the inner ring 21, the inner ring 21 and the inner edge 21a of the inner ring 21. FIG. 3A is an expanded view of the magnetic gap 5, substantially bisected by the voice coil 10 comprising the winding 11 and former 12 into magnetic gap portions 5a and 5b.

As shown in FIG. 4, the motor assembly 4 comprises a first magnet system 24 and a second magnet system 26. The second magnet system 26 may be concentrically aligned along radial axis 39 inside the first magnet system 24 such that the outer diameter of the second magnet system D26b is smaller than the inner diameter of the first magnet system D24a. Each magnet system may be made from a plurality of radially polarized arc magnets 28 fixed in an annular ring. The plurality of arc magnets 28 forming the first magnet system 24 may be attached to the inner edge 20a of the outer ring 20 (See FIG. 2.) or they may be attached to each other to form an annular ring before attachment to the inner edge 20a of the outer ring 20. Similarly, the plurality of arc magnets 28 forming the second magnet system 26 may be attached to the outer edge 21b of the inner ring 21 to form an annular ring or they may be attached to each other to form an annular ring before attachment to the outer edge of the inner ring 21b. The first magnet system 24 or the second magnet system 26 may be encapsulated in epoxy. The first and second magnet systems 24, 26 may preferably be aligned along the long axis 40.

Continuing with FIG. 4A depicts the magnetic pole arrangement for two of the plurality of arc magnets 28. In this embodiment, the poles are aligned such that a southern pole may be at the outer edge 24b of the first magnet system 24, a northern pole may be at the inner edge 24a of the first magnet system 24, a southern pole may be at the outer edge 26b of the second magnet system 26 and a northern pole may be located at the inner edge 26a of the second magnet system 26. In another embodiment, the poles may be reversed for each magnet system. The lines of magnetic flux coupling the two magnet systems are shown in FIG. 4A flowing symmetrically across the magnetic gap 5. A preferred embodiment of the motor assembly illustrated in FIG. 4, may be symmetrically aligned about both its long and radial axes.

FIG. 5 is a cross-section view of one embodiment of a voice coil support assembly 9 of this disclosure. The voice coil support assembly 9 comprises the voice coil 10 and opposing upper and lower suspensions 14, 16, which may have a mirror like image with opposing symmetrical shapes about the radial axis 39. The outer edge 14b of the upper suspension 14 may be configured for adhesion to a speaker driver frame (not shown), preferably above a motor assembly (not shown). The inner edge 14a of the upper suspension 14 may be adhered to the outer periphery 12d of the former 12 at the upper end 12a of the former 12. The outer edge 16b of the lower suspension 16 may be configured for adhesion to a speaker driver frame (not shown), preferably below a motor assembly (not shown). The inner edge 16a of the lower suspension 16 may be adhered to the outer periphery 12d of the former 12 at the lower end 12b of the former 12. Thus, the voice coil 10, which comprises a winding 11 and a former 12, may be supported on its upper and lower ends 10a, 10b by the upper and lower suspensions 14, 16. The voice coil 10 may optionally have a collar (not shown). For voice coils without collars, the ends of the former 12a, 12b and ends of the voice coil 10a, 10b are coincident. The voice coil support system 9 illustrated in FIG. 5, is substantially symmetrical about its long axis 40 and radial axis 39. The length of the winding L₂ may be at least twenty percent of the length of the former L₃ Preferably the length of the winding L₂, may be from about twenty percent to about 90 percent of the length of the former L₃. The cone 18, shown in phantom, may be adhered to voice coil support assembly 9 at the inner periphery 12c of the former 12 at the upper end 12a of the former 12 along the circumferential edge 18a of the cone 18. In the illustrated embodiment, the diameter of the voice coil D10 is larger than the diameter of the cone D18.

FIG. 6A is a cross-sectional top view of an outer ring 20 for use in a frame embodiment of this disclosure. The outer ring 20 may be a solid ring configuration (not shown) or may be a hoop and spoke configuration. The outer perimeter of the outer ring 20 may form an outer edge 20b of the outer ring 20 that may have optional opening 20f (not shown) for fasteners which may be used to attach the outer ring 20 to the shank area 7 of the j-beams 6 of the frame 2 as seen in FIG. 2 to the left of the long axis 40 or the outer ring 20 may be attached to the frame 2 with an adhesive as seen to the right of the long axis 40 in FIG. 2. The outer ring 20 may also have a hoop 20e whose inner perimeter forms the inner edge 20a of the outer ring 20. A motor assembly (not shown) may be attached to the inner edge 20a of the outer ring 20.

FIG. 6B is a cross-sectional top view of an inner ring 21 for use in a frame embodiment of this disclosure. A motor assembly (not shown) may be attached to the outer edge 21b of the inner ring 21. The inner edge 21a of the inner ring 21, may have optional openings 21f for use with fasteners (not shown) to attach the inner ring 21 to a hook section 36 of the j-beams 6 of the frame 2 (not shown). Alternatively, the inner ring may be adhered to a frame (not shown).

FIG. 6C is a cross-sectional top view of an upper ring 3 for use in a frame embodiment of this disclosure. The upper ring 3 may be adapted for mounting a speaker driver (not shown) to a speaker cabinet (not shown) through the optional opening 3f in the ring 3. The upper ring 3 may be integrally formed with a frame (not shown), opening 30f, illustrated in FIG. 6C, may be provided in the upper ring 3 which aligns with opening 7f in the shank area 7 of the j-beam 6 use with fasteners (not shown) to attach the upper ring 3 to a j-beam 6 of a frame 2 (not shown). The openings 30f may be in a polygonal arrangement, for example a hexagon, as seen in FIG. 6C. The inner edge 3a of upper ring 3 may be adapted to provide a surface for adhesion of the outer edge 14b of the upper suspension 14 (not shown).

FIG. 6D is a cross-sectional top view of a lower ring 22 for use with a frame embodiment of this disclosure. The outer edge 22b of the lower ring 22 may be inserted in a recess 7n at the lower end 6b of a j-beam 6 (See FIG. 6E.) to facilitate arrangement of the j-beams 6 and provide frame rigidity. The inner edge 22a of the lower ring 22 may provide a surface for adhesion of the outer edge 16b of the lower suspension 16 (not shown).

FIG. 6E is a cross-sectional side view of a j-beam 6 for use with a frame embodiment of this disclosure. The j-beam 6 may have a shank area 7 and hook area 36. The j-beam 6 may also have an upper edge 36a atop the hook area 36 and an upper edge 7a atop the shank area 7. A recess 7n may be formed within the inner periphery 7d of the shank area 7 of the j-beam 6 for insertion of the lower ring (See also FIG. 6D). The lower end 6b of the j-beam 6 has a base 34 illustrated by the flattened area. The j-beam 6 may have optional openings 7f, 36f for fasteners.

FIG. 6F is a top view of an assembled frame 2 embodiment of this disclosure using six j-beams 6. The j-beams 6 may be held substantially equidistant by the upper ring 3 and the lower ring 22 (shown in phantom) with the hook area 36 of each j-beam 6 arranged inwardly from the outer edge 3b and the inner edge 3a of the upper ring 3. The shank area 7 of the j-beam 6 is shown in phantom. Optional fastener openings 30f and 7f and 21f and 36f may be provided for attaching the upper edge 7a of shank area 7 of the j-beam 6 to the upper ring 3 and the upper edge 36a of the hook area 36 of the j-beam 6 to the inner ring 21, respectively. Also illustrated is an opening 3f in the upper ring 3 for fasteners to mount the speaker driver to a speaker cabinet (not shown).

FIG. 7 The speaker driver frame 2 comprising three j-beams 6, a motor assembly 4 and a magnetic gap 5 are illustrated. The j-beams 6, as depicted in FIG. 6E, may have an upper end 6a, a lower end 6b, a shank area 7, a recess 7n within the inner periphery 7d of the shank area 7, and a hook area 36. The lower end 6b of the j-beam 6 may have a base 34 illustrated by the flattened area. As shown in FIG. 7, the frame 2 may be assembled using an upper ring 3, a lower ring 22, an outer ring 20 and an inner ring 21. The j-beams 6 are preferably arranged equidistant from each other along a radial axis 39. The upper ring 3 in FIG. 7 may be attached to the j-beams 6 using means known in the art. Openings 30f and 7f, 20f, and 21f and 36f may be provided for fasteners for attaching the upper ring 3 to the shank area 7 of the j-beam 6, the outer ring 20 to the shank area 7 of the j-beam 6 and the inner ring 21 to the hook area 36 of the j-beam 6, respectively. An opening 3f may be provided in the upper ring 3 to mount the speaker driver to a speaker cabinet (not shown). The outer ring 20 may be used to attach the first magnet system 24 along the inner edge 20a of the outer ring 20. The inner ring 21 may be used to attach the second magnet system 26 along the outer edge 21b of the inner ring 21. The magnetic gap 5 is formed between the first and second magnet systems 25, 26.

The foregoing description is directed to particular embodiments of the present disclosure for the purpose of illustration and explanation. It will be apparent, however, to one skilled in the art that many modifications and changes to the embodiment set forth above are possible without departing from the scope of the disclosure.

I claim:

1. A speaker driver comprising a motor assembly, said motor assembly being substantially symmetrical about a radial axis and a long axis.

2. A speaker driver comprising a voice coil having an upper end and a lower end wherein said voice coil being supported at said upper end and said lower end.

3. A speaker driver comprising:
(a) a frame;
(b) a motor assembly disposed within said frame;
(c) a voice coil disposed moveably within a magnetic gap formed within said motor assembly;
(d) an upper suspension adhered to an outer periphery of said voice coil and said frame above said motor assembly;
(e) a lower suspension adhered to said outer periphery of said voice coil and said frame below said motor assembly; and
(f) a cone adhered to an inner periphery of said voice coil above said motor assembly.

4. The speaker driver of claim 3 wherein said upper suspension and said lower suspension are substantially symmetrical about a long axis of said speaker driver.

5. The speaker driver of claim 3 wherein said motor assembly, said upper suspension and said lower suspension are substantially symmetrical about a long axis and a radial axis of said speaker driver.

6. The speaker driver of claim 3 wherein a diameter of said voice coil is from about ninety percent to about one hundred ten percent of a diameter of said cone.

7. The speaker driver of claim 3, wherein said upper suspension and said lower suspension have arcuate shapes.

8. The speaker driver of claim 3 wherein said upper suspension and said lower suspension have opposing arcuate shapes.

9. The speaker driver of claim 3 wherein said upper suspension and said lower suspension have corrugated shapes.

10. The speaker driver of claim 3 wherein said voice coil is overhung.

11. The speaker driver of claim 3 wherein said voice coil is evenhung.

12. The speaker driver of claim 3 wherein said voice coil is underhung.

13. The speaker driver of claim 3, wherein said voice coil comprises a winding and a former, said winding having a length at least twenty percent the length of said former).

14. The speaker driver of claim 3, wherein said voice coil comprises a winding and a former, said winding having a length from about thirty percent to about eighty percent of a length of said speaker driver.

15. The speaker driver of claim 3, wherein said voice coil comprises a winding and a former, said winding having a length from about two hundred percent to about two thousand percent of a length of said magnetic gap.

16. The speaker driver of claim 3 wherein said frame is non-ferromagnetic.

17. The speaker driver of claim 3 wherein said frame is aluminum.

18. A speaker driver comprising:
(a) a frame having an upper end and a lower end;
(b) a motor assembly disposed within said frame;
(c) a voice coil disposed moveably within a magnetic gap concentrically formed within said motor assembly, said voice coil comprising a winding and a former, said former having an upper end, a lower end, an inner periphery and an outer periphery;
(d) an upper suspension having an inner edge (14a) adhered to said outer periphery of said former at said upper end of said former and an outer edge adhered to said upper end of said frame above said motor assembly;
(e) a cone adhered to said inner periphery of said former at said upper end of said former;
(f) a lower suspension having an inner edge (16a) adhered to said outer periphery of said former at said lower end of said former and an outer edge adhered to said lower end of said frame below said motor assembly.

19. A voice coil support system for use in a speaker driver wherein an upper suspension and a lower suspension are opposingly adhered to an outer periphery of a voice coil at opposing ends of said voice coil.

20. The voice coil support system of claim 19 wherein said upper suspension and said lower suspension have opposing symmetrical shapes.

21. A voice coil support system comprising an upper suspension (14), a lower suspension and a former, said former having an upper end (12a), a lower end and an outer periphery wherein said upper suspension is adhered to said outer periphery of said former at said upper end of said former and said lower suspension is adhered to said outer periphery of said former at said lower end of said former, wherein said voice coil support system is substantially symmetrical about a long axis and a radial axis.

22. A voice coil support assembly for a speaker driver comprising:
(a) a former having an upper end, a lower end and an outer periphery;
(b) an upper suspension having an inner edge and an outer edge wherein said inner edge of said upper suspension is adhered to said outer periphery of said former at said upper end of said former and said outer edge of said upper suspension is adapted for adhesion to an upper end of a frame above a motor assembly;
(c) a lower suspension having an inner edge and an outer edge wherein said inner edge of said lower suspension is adhered to said outer periphery of said former at said lower end of said former and said outer edge of said lower suspension is adapted for adhesion to a lower end of a frame below said motor assembly.

23. A motor assembly for a speaker driver comprising:
(a) a first magnet system fixed in an annular ring forming an inner diameter and an outer diameter;
(b) a second magnet system fixed in an annular ring forming an inner diameter and an outer diameter wherein said outer diameter of said second magnet system is smaller than said inner diameter of said first magnet system; and
(c) a magnetic gap formed between said inner diameter of said first magnet system and said outer diameter of said second magnet system whereby said first magnet system and said second magnet system are operatively coupled by a magnetic flux wherein at least one magnetic system comprises a plurality of radially polarized arc magnets.

24. A motor assembly for a speaker driver comprising:
(a) a first magnet system comprising a plurality of radially polarized arc shaped permanent magnets fixed in an annular ring forming an inner diameter and an outer diameter;
(b) a second magnet system comprising a plurality of radially polarized arc shaped permanent magnets fixed in an annular ring forming an inner diameter and an outer diameter wherein said outer diameter of said second magnet system is smaller than said inner diameter of said first magnet system; and
(c) a magnetic gap formed between said inner diameter of said first magnet system and said outer diameter of said second magnet system whereby said first magnet system and said second magnet system are operatively coupled by a magnetic flux.

25. The motor assembly of claim 24 wherein said plurality of radially polarized arc shaped permanent magnets forming said annular ring has from about one to about forty five degrees of arc.

26. A motor assembly of claim 24 wherein said motor assembly is symmetrical about a long axis and a radial axis of said motor assembly.

27. A frame for a speaker driver comprising:
(a) at least three j-beams, said at least three j-beams having an upper end, a lower end, a shank area, a hook area and a recess, said recess being formed within an inner periphery of said shank area near said lower end of said j-beam, said lower end of said at least three j-beams having a base and an upper end of said hook area;
(b) an upper ring, said upper ring having an inner edge, an outer edge, a top surface and a bottom surface, said upper ring adapted for mounting said at least three j-beams in a polygonal arrangement, said hook areas of said at least three j-beams arranged inwardly of said outer edge of said upper ring;
(c) a lower ring having an inner edge and an outer edge, said outer edge of said lower ring being held within said recesses of said at least three j-beams;
(d) an outer ring having an inner edge and an outer edge, said outer edge of said outer ring attached to said inner periphery of said shank area of said at least three j-beams substantially equidistant from said upper ring and said lower ring; and
(e) an inner ring adapted for mounting on said upper end of said hook area, said inner ring being concentrically aligned with said outer ring.

28. A speaker driver for use in a speaker driver comprising:
(a) at least three j-beams, said at least three j-beams having an upper end, a lower end, a shank area, a hook area and a recess, said recess being formed within an inner periphery of said shank area near said lower end of said j-beam, said lower end of said j-beam having a base and an upper end of said hook area;
(b) an upper ring, said upper ring having an inner edge, an outer edge, a top surface and a bottom surface, said upper ring adapted for mounting said at least three j-beams in a polygonal arrangement, said hook areas of said at least three j-beams being arranged inwardly of said outer edge of said upper ring;
(c) a lower ring having an inner edge and an outer edge, said outer edge of said lower ring being held within said recesses of said at least three j-beams;
(d) an outer ring having an inner edge and an outer edge, said outer edge of said outer ring attached to said inner periphery of said shank area substantially equidistant from said upper ring and said lower ring;
(e) an inner ring having an inner edge and an outer edge, said inner ring adapted for mounting on said upper end of said hook area, said inner ring being concentrically aligned with said outer ring;
(f) a first magnet system attached to said inner edge of said outer ring;
(g) a second magnet system attached to said outer edge of said inner ring forming a magnetic gap between said first magnet system and said second magnet system and wherein said first magnet system and said second magnet system form a radially aligned motor assembly;
(h) a voice coil disposed moveably within said magnetic gap, said voice coil comprising a winding and a former, said former having an upper end, a lower end, an inner periphery and an outer periphery;
(i) an upper suspension having an inner edge adhered to said outer periphery of said former at said upper end of said former and an outer edge adhered to said inner edge of said upper ring above said motor assembly;
(j) a cone adhered to said inner periphery of said former at said upper end of said former; and
(k) a lower suspension having an inner edge adhered to said outer periphery of said former at said lower end of said former and an outer edge adhered to said inner edge of said lower ring below said motor assembly.

29. The speaker driver of claim 28 wherein said first magnet system and second magnet system comprise a plurality of arc shaped magnets.
